(19) United States
(12) Patent Application Publication
(10) Pub. No.: US 2021/0192286 A1
(43) Pub. Date: Jun. 24, 2021

(54) MODEL TRAINING METHOD AND ELECTRONIC DEVICE

(71) Applicant: Coretronic Corporation, Hsin-Chu (TW)

(72) Inventors: Yi-Fan Liou, Hsin-Chu (TW); Po-Yen Tseng, Hsin-Chu (TW)

(73) Assignee: Coretronic Corporation, Hsin-Chu (TW)

(21) Appl. No.: 17/126,054

(22) Filed: Dec. 18, 2020

(30) Foreign Application Priority Data
Dec. 24, 2019 (CN) 201911345060.6

(51) Int. Cl. G06K 9/62; G06N 3/04; G06T 5/20

(52) U.S. Cl. CPC G06K 9/6257; G06T 5/20; G06N 3/0454

(57) ABSTRACT

A model training method and an electronic device are provided. The method includes: obtaining a first image; masking at least one region in the first image to obtain a masked image; inputting the masked image to a first model to obtain a first generated image; training the first model according to the first generated image and the first image; training a second model according to the first generated image and the first image; and when the first model is trained to a first condition and the second model is trained to a second condition, completing the training for the first model. By means of the model training method and the electronic device, the problem brought by a manually marked image can be resolved and the problem of causing mode collapse can be effectively avoided.

### CROSS-REFERENCE TO RELATED APPLICATION

This application claims the priority benefit of China application serial no. 201911345060.6, filed on Dec. 24, 2019. The entirety of the above-mentioned patent application is hereby incorporated by reference herein and made a part of this specification.

### BACKGROUND

### Technical Field

The disclosure relates to a model training method and an electronic device.

### Description of Related Art

In the automated optical inspection (AOI) field, if a method such as machine learning or deep learning is to be used, a marked image usually needs to be used to train a model. However, the model is usually marked manually, which costs a lot of manpower and time, and the manually marked image may have problems of mark missing and mismark of features. When a problematic image is used to train a model, the problem of a poor model learning effect is often caused.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

The invention provides a model training method and an electronic device which can resolve the problem caused by a manually marked image and effectively avoid causing mode collapse.

Other objectives and advantages of the invention may be further understood from the technical features disclosed in the invention.

To achieve the foregoing one or some or all objectives or other objectives, the invention provides a model training method, including: obtaining a first image; masking at least one region in the first image to obtain a masked image; inputting the masked image to a first model to obtain a first generated image; training the first model according to the first generated image and the first image; training a second model according to the first generated image and the first image; and when the first model is trained to a first condition and the second model is trained to a second condition, completing the training for the first model.

The invention provides an electronic device, including: an input circuit and a processor. The input circuit is configured to obtain a first image. The processor is coupled to the input circuit and configured to perform the following operations: masking at least one region in the first image to obtain a masked image; inputting the masked image to a first model to obtain a first generated image; training the first model according to the first generated image and the first image; training a second model according to the first generated image and the first image; and when the first model is trained to a first condition and the second model is trained to a second condition, completing the training for the first model.

Based on the above, the model training method and the electronic device of the invention can automatically find out a specific region in a to-be-detected image instead of manually marking a specific region (for example, a flawed region) in the image to train a model, thereby resolving the problem brought by the manually marked image.

Other objectives, features and advantages of the invention will be further understood from the further technological features disclosed by the embodiments of the invention where there are shown and described exemplary embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electronic device according to an embodiment of the invention.

FIG. 2 is a schematic diagram of a neural network module according to an embodiment of the invention.

FIG. 3 is a flowchart of a model training method according to an embodiment of the invention.

FIG. 4 is a flowchart of a method for using a first model to identify a specific region in an image according to an embodiment of the invention.

FIG. 5 is a schematic diagram of a first image and a masked image according to an embodiment of the invention.

FIG. 6 is a schematic diagram of identifying a flawed region in a to-be-detected image according to an embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted”, and variations thereof herein are used broadly and encompass direct and indirect connections, couplings, and mountings.

Now the examples of the embodiments are described in detail in the accompanying drawings with reference to the embodiments of the invention. In addition, in any possible position, elements/components using same mark numbers in the accompanying drawings and implementations represent same or similar parts. The foregoing and other technical content, characteristics, and effects about the invention will be clearly presented in the following detailed description with reference to an exemplary embodiment of the accompanying drawings. The direction term mentioned in the following embodiments, such as: upper, lower, left, right, front, or rear, is only a direction with reference to the accompanying drawings. Therefore, the used direction term is used for describing instead of limiting the invention.

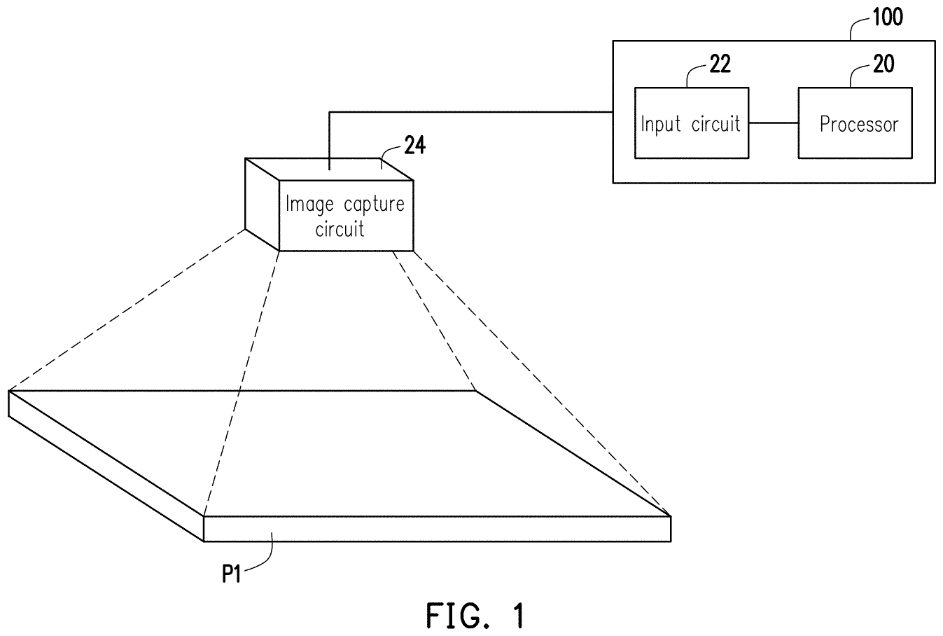

FIG. 1 is a schematic diagram of an electronic device according to an embodiment of the invention. Referring to FIG. 1, the electronic device 100 includes a processor 20 and an input circuit 22. The input circuit 22 is coupled to the processor 20.

The processor 20 may be a central processing unit (CPU), or another programmable general or dedicated microprocessor, a digital signal processor (DSP), a programmable controller, an application-specific integrated circuit (ASIC), another similar element, or a combination of the foregoing elements.

The input circuit 22 is, for example, an input interface or circuit configured to obtain related data from the outside of the electronic device 100 or other sources. In this embodiment, the input circuit 22 is coupled to an image capture circuit 24. The image capture circuit 24 uses, for example, a charge coupled device (CCD) lens, a lens with a complementary metal oxide semiconductor (CMOS), or a video camera and a camera of an infrared lens. The image capture circuit 24 is configured to capture an object on a light guide plate P1 to obtain an image. However, in other embodiments, the input circuit 22 may also obtain an image from other storage media, which is not limited herein.

In addition, the electronic device 100 may also include a storage circuit (not shown in the figure), and the storage circuit is coupled to the processor 20. The storage circuit may be a fixed or removable random access memory (RAM) in any form, a read-only memory (ROM), a flash memory, a similar element, or a combination of the foregoing elements.

In this embodiment, the storage circuit of the electronic device 100 stores a plurality of code segments. After being installed, the code segments are executed by the processor 20. For example, the storage circuit includes a plurality of modules, and the modules respectively perform operations applied to the electronic device 100. Each module includes one or more code segments, but the invention is not limited thereto. The operations of the electronic device 100 may also be implemented in a manner of using other hardware forms.

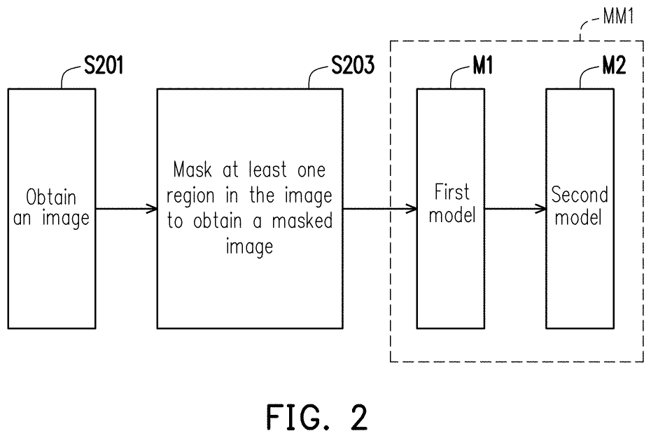

FIG. 2 is a schematic diagram of a neural network module according to an embodiment of the invention. Referring to FIG. 2, in this embodiment, the processor 20 may first configure a neural network module MM1. The neural network module MM1 includes a first model M1 and a second model M2. In step S201, the input circuit 22 may obtain an image captured by, for example, the image capture circuit 24. Then, in step S203, the processor 20 may use a block in a preset size to mask at least one region in the image obtained in step S201 to obtain a masked image. The block may be a block including a plurality of pixels of a single color (such as black, white, grey, or another color). Then, the processor 20 may input the masked image to the neural network module MM1 to adjust weights in the first model M1 and the second model M2.

In this embodiment, the first model is an auto encoder and the second model is a guess discriminator. The auto encoder uses an unsupervised learning method of a neural network. The auto encoder includes an encoder and a decoder to generate a generated image according to an input image. A person skilled in the art may learn that, an architectures of an auto encoder and a variational auto encoder is an unsupervised neural network including an encoder and a decoder. The first model (for example, the auto encoder) is mainly configured to transform an input image into a generated image. In this embodiment, it is assumed that the input image is an image (also referred to as a flawed image) with a specific region (for example, a flawed region), and the auto encoder is mainly configured to transform the input image into an image (also referred to as a normal image) without the specific region.

In addition, in this embodiment, an input of the guess discriminator is an input image inputted to the auto encoder and a generated image that is generated by the encoder and that corresponds to the input image, and the guess discriminator is configured to distinguish which image is an input image inputted to the auto encoder and which image is a generated image generated by the encoder. During the distinguishing, in this embodiment, the guess discriminator superimposes the input image and the generated image according to different sequences at the same time to generate a plurality of combinations for distinguishing. By means of this manner, compared with a general guess discriminator, the problem of causing mode collapse can be effectively avoided. In addition, by means of this manner, the problem of self-adversarial attack in the field of image to image translation can be effectively resolved.

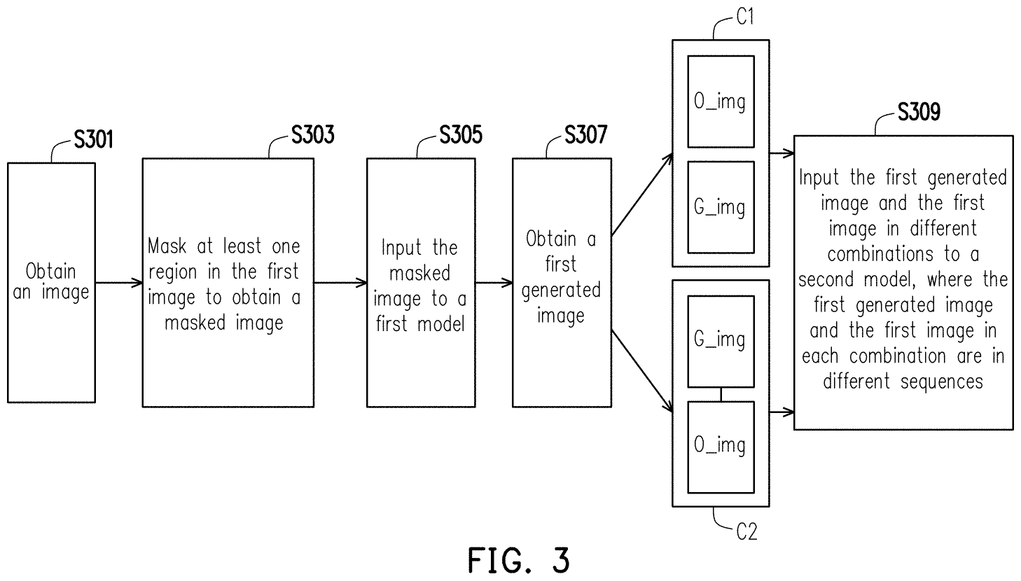

FIG. 3 is a flowchart of a model training method according to an embodiment of the invention.

Referring to FIG. 3, FIG. 3 is used for more specifically describing how to train the first model M1 and the second model M2 in the neural network module MM1 to adjust weights in the first model M1 and the second model M2. First, in step S301, the input circuit 22 obtains a first image O_img. In this embodiment, the first image O_img may be obtained by the processor 20 by obtaining, through the input circuit 22, raw data (also referred to as a raw image) captured by the image capture circuit 24, and cutting the raw data according to a preset size. However, in other embodiments, the first image O_img may also be uncut raw data. In addition, in this embodiment, the processor 20 may randomly cut the raw data according to different sizes to obtain a plurality of sub-images, and use one of the sub-images as the first image O_img. Cutting the raw image according to different sizes can avoid using the same pattern in the subsequent model training for model learning.

Then, similar to step S203, in step S303, the processor 20 may use a block in a preset size to mask at least one region in the first image O_img to obtain a masked image, and it is default that the size may be set to a certain size or an uncertain size. The block may be a block of a single color. In step S305, the processor 20 inputs the masked image to the first model M1. In step S307, the processor 20 obtains a first generated image G_img that is generated by the first model M1 and that corresponds to the first image O_img. Then, the processor 20 trains the first model M1 and the second model M2 according to the first generated image G_img and the first image O_img. When the first model M1 is trained to a first condition and the second model M2 is trained to a second condition, the processor 20 completes the training for the first model M1.

More specifically, in the process of training the first model M1 to the first condition, the processor 20 adjusts a plurality of weights (also referred to as first weights) in the first model M1, so that a value of a loss function (also referred to as a loss function value) calculated according to the first generated image G_img and the first image O_img reaches a minimum value. It means that the first condition defines a value of a loss function reaching a minimum value in the first model M1. The loss function may be a mean square error, a Kullback-Leibler (KL) divergence, a cross-entropy, or the like, which is not limited herein.

In addition, in the process of training the second model M2 to the second condition, in step S309, the processor 20 inputs the first generated image G_img and the first image O_img in different combinations C1˜C2 to the second model M2. The processor 20 adjusts a plurality of weights (also referred to as second weights) in the second model M2, so that a loss function value calculated according to the plurality of combinations C1˜C2 of the first generated image G_img and the first image O_img reaches a maximum value. It means that the second condition defines a value of a loss function reaching a maximum value in the second model M2. Particularly, a sequence of the first generated image G_img and the first image O_img is different in each of the combinations C1˜C2. Using FIG. 3 as an example, the combination C1 is, for example, superimposing the first image O_img on the first generated image G_img, and the combination C2 is, for example, superimposing the first generated image G_img on the first image O_img.

Particularly, when the first model M1 is trained to the first condition and the second model M2 is trained to the second condition, the second model M2 cannot distinguish which image of the first image O_img and the first generated image G_img is generated (or outputted) by the first model M1. In this case, the processor 20 completes the training for the first model M1, and the trained first model M1 may be used to identify whether the image has a specific region (for example, having a flawed region).

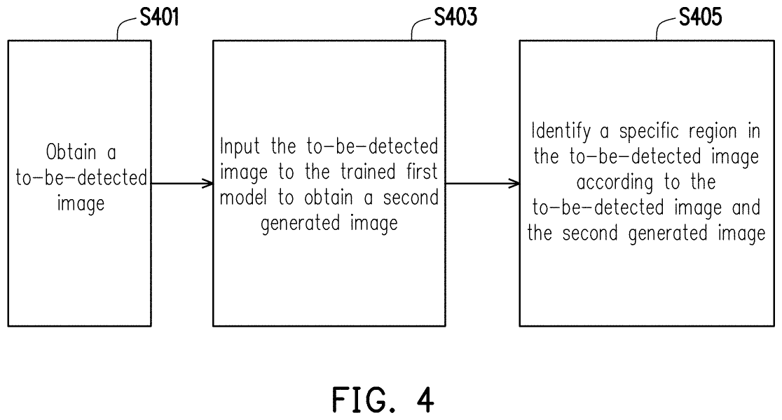

For example, FIG. 4 is a flowchart of a method for using a first model to identify a specific region in an image according to an embodiment of the invention.

Referring to FIG. 4, in step S401, the processor 20 obtains a to-be-detected image. The to-be-detected image is, for example, obtained by the processor 20 by obtaining, through the input circuit 22, raw data captured by the image capture circuit 24, and cutting the raw data according to a preset size. However, in other embodiments, the to-be-detected image may also be uncut raw data. Then, in step S403, the processor 20 inputs the to-be-detected image to the trained first model M1 to obtain a generated image (also referred to as a second generated image). Then, in step S405, the processor 20 identifies a specific region in the to-be-detected image according to the to-be-detected image and the second generated image. More specifically, using the specific region being a flawed region as an example, the processor 20 subtracts the to-be-detected image and the second generated image from each other to identify the flawed region in the to-be-detected image. For example, in this embodiment, after the to-be-detected image and the second generated image are subtracted from each other, a general image processing method may be used to remove noise in an image obtained after the subtraction, and identify pixels, in the image obtained after the subtraction, whose pixel values are greater than a threshold to be flaws. The pixels of the threshold are, for example, 5×5 pixels, but are not limited thereto.

That is, by means of the training of the first model M1 and the second model M2, the first model M1 may automatically find out a specific region in the to-be-detected image instead of manually marking a specific region (for example, a flawed region) in the image to train a model, thereby resolving the problem brought by the manually marked image.

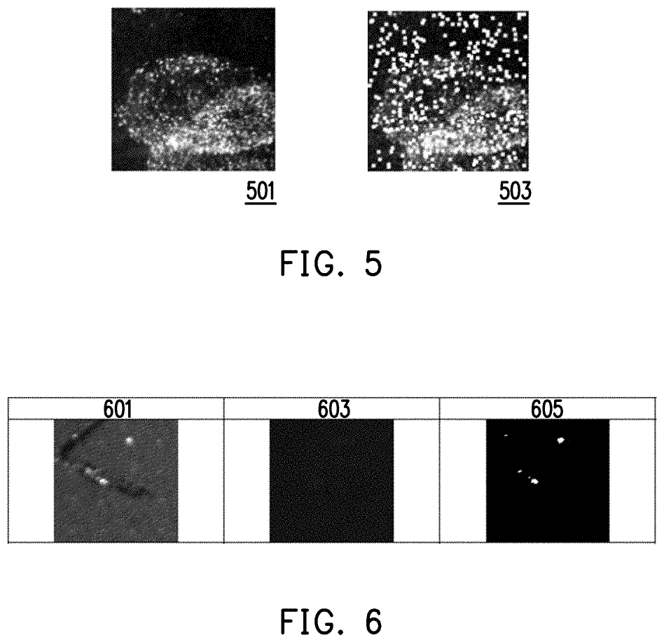

FIG. 5 is a schematic diagram of a first image and a masked image according to an embodiment of the invention.

Referring to FIG. 5, assuming that an image 501 is the first image obtained in step S301, and after step S303, an image 503 may be obtained. As shown in the image 503, the image 503 has a plurality of regions masked by white blocks, and the image 503 may serve as the foregoing masked image.

In addition, FIG. 6 is a schematic diagram of identifying a flawed region in a to-be-detected image according to an embodiment of the invention.

Referring to FIG. 6, it is assumed that an image 601 is the to-be-detected image obtained in step S401. The processor 20 may input the image to the trained first model M1 to obtain an image 603 (that is, the foregoing generated image). Then, when a flawed region in the image 601 is identified, the processor 20 subtracts the image 601 and the image 603 from each other to obtain an image 605. The processor 20 may identify, in the image 601, a corresponding white region in the image 605 as the flawed region in the image 601.

Based on the above, the model training method and the electronic device of the invention can automatically find out a specific region in a to-be-detected image instead of manually marking a specific region (for example, a flawed region) in the image to train a model, thereby resolving the problem brought by the manually marked image.

The foregoing content is merely exemplary embodiments of the invention, and cannot be used for limiting the scope of the implementations of the invention. That is, any simple equivalent change and modification made to the claims and the description content of the invention shall fall within the scope covered by the patent of the invention. In addition, any embodiment or claim of the invention does not need to implement all objectives or advantages or characteristics disclosed in the invention. In addition, the abstract and the title are used for assisting search of the patent document, instead of limiting the protection scope of the invention. In addition, the terms “first” and “second” mentioned in the specification or claims are only used for naming elements or distinguishing different embodiments or scopes, instead of limiting the upper limit or the lower limit of the quantity of elements.

The foregoing description of the exemplary embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A model training method, comprising:
obtaining a first image;
masking at least one region in the first image to obtain a masked image;
inputting the masked image to a first model to obtain a first generated image;
training the first model according to the first generated image and the first image;
training a second model according to the first generated image and the first image; and
completing the training for the first model when the first model is trained to a first condition and the second model is trained to a second condition.

2. The model training method according to claim 1, wherein the step of training the first model to the first condition comprises:
adjusting a plurality of first weights in the first model, so that a loss function value calculated according to the first generated image and the first image is a minimum value.

3. The model training method according to claim 1, wherein the step of training the second model to the second condition comprises:
adjusting a plurality of second weights in the second model, so that a loss function value calculated according to a plurality of combinations of the first generated image and the first image is a maximum value, wherein
a sequence of the first generated image and the first image is different in each of the plurality of combinations.

4. The model training method according to claim 1, wherein in the step of obtaining the first image, the model training method further comprises:
obtaining raw data; and
cutting the raw data to obtain the first image.

5. The model training method according to claim 1, further comprising:
inputting a to-be-detected image to the trained first model to obtain a second generated image; and
identifying a specific region in the to-be-detected image according to the to-be-detected image and the second generated image.

6. The model training method according to claim 5, wherein the specific region is a flawed region, and the step of identifying the specific region in the to-be-detected image according to the to-be-detected image and the second generated image comprises:
subtracting the to-be-detected image and the second generated image from each other to identify the flawed region.

7. The model training method according to claim 1, wherein the first model is an auto encoder and the second model is a guess discriminator.

8. An electronic device, comprising an input circuit and a processor, wherein
the input circuit is configured to obtain a first image; and
the processor is coupled to the input circuit, wherein
the processor masks at least one region in the first image to obtain a masked image,
the processor inputs the masked image to a first model to obtain a first generated image,
the processor trains the first model according to the first generated image and the first image,
the processor trains a second model according to the first generated image and the first image, and
the processor completes the training for the first model when the first model is trained to a first condition and the second model is trained to a second condition.

9. The electronic device according to claim 8, wherein in the operation of training the first model to the first condition,
the processor adjusts a plurality of first weights in the first model, so that a loss function value calculated according to the first generated image and the first image is a minimum value.

10. The electronic device according to claim 8, wherein in the operation of training the second model to the second condition,
the processor adjusts a plurality of second weights in the second model, so that a loss function value calculated according to a plurality of combinations of the first generated image and the first image is a maximum value, wherein
a sequence of the first generated image and the first image is different in each of the plurality of combinations.

11. The electronic device according to claim 8, wherein in the operation of obtaining the first image,
the processor obtains raw data, and
the processor cuts the raw data to obtain the first image.

12. The electronic device according to claim 8, wherein
the processor inputs a to-be-detected image to the trained first model to obtain a second generated image, and
the processor identifies a specific region in the to-be-detected image according to the to-be-detected image and the second generated image.

13. The electronic device according to claim 12, wherein the specific region is a flawed region, and in the operation of identifying the specific region in the to-be-detected image according to the to-be-detected image and the second generated image,
the processor subtracts the to-be-detected image and the second generated image from each other to identify the flawed region.

14. The electronic device according to claim 8, wherein the first model is an auto encoder and the second model is a guess discriminator.
